(19) United States
(12) Patent Application Publication
(10) Pub. No.: US 2018/0121557 A1
(43) Pub. Date: May 3, 2018

(54) Multi-Tiered Safety Control System and Methods for Online Communities

(71) Applicants: Mark A. Dinan, Pasadena, CA (US); Jennifer Y. Sun, Pasadena, CA (US); Ann M. Pickard, South Pasadena, CA (US); James M. Bower, Ashland, OR (US); Munir F. Bhatti, Arcadia, CA (US); Joseph Vaughn Lewis Cook, Altadena, CA (US)

(72) Inventors: Mark A. Dinan, Pasadena, CA (US); Jennifer Y. Sun, Pasadena, CA (US); Ann M. Pickard, South Pasadena, CA (US); James M. Bower, Ashland, OR (US); Munir F. Bhatti, Arcadia, CA (US); Joseph Vaughn Lewis Cook, Altadena, CA (US)

(21) Appl. No.: 15/859,257

(22) Filed: Dec. 29, 2017

Related U.S. Application Data
(63) Continuation-in-part of application No. 11/402,486, filed on Apr. 11, 2006, now abandoned.
Application No. 11/402,486 is a continuation-in-part of application No. 10/123,121, filed on Apr. 29, 2002, now abandoned.
(60) Provisional application No. 60/288,888, filed on May 3, 2001.

(51) Int. Cl. G06F 17/30; H04L 12/58

(52) U.S. Cl. CPC G06F 17/30867; H04L 51/32; H04L 51/12

(57) ABSTRACT

A system and method of maintaining community safety standards within an Internet community. A balance is achieved between open communication and costly supervision of an immersive online community by use of automated algorithms, human supervision and peer monitoring. An automated filtering process is used in conjunction with an evaluation and penalty process. The filter is enhanced over time. A peer-to-peer control and peer-to-administrator reporting scheme complete the system and methods to synergistically maintain safety and set standards within the community.

### CROSS-REFERENCE TO RELATED APPLICATIONS

This application is a continuation-in-part of prior application Ser. No. 11/402,486, filed on Apr. 11, 2006 and entitled “Multi-Tiered Safety Control System and Methods for Online Communities”, which is a continuation-in-part of prior application Ser. No. 10/123,121, entitled “Multi-Tiered Safety Control System and Methods for Online Communities”, filed Apr. 29, 2002, which claims priority to U.S. Provisional Patent Application No. 60/288,888, entitled “Multi-Tiered Safety Control System and Methods for Online Communities”, filed on May 3, 2001, Said applications are hereby incorporated by reference in their entireties.

### STATEMENT REGARDING FEDERALLY SPONSORED RESEARCH OR DEVELOPMENT

Not Applicable.

### NAMES OF THE PARTIES TO A JOINT RESEARCH AGREEMENT

Not Applicable.

### INCORPORATION BY REFERENCE OF MATERIAL SUBMITTED ON A COMPACT DISK

Not Applicable.

### FIELD OF THE INVENTION

The present invention relates to a system and methods for maintaining safe and appropriate behavior in chat communities on the Internet.

### BACKGROUND OF THE INVENTION

With the evolution of increasingly sophisticated Internet tools and the advent of broadband connections, the world-wide web (Web) experience is moving steadily beyond the passive dissemination of information, towards real-time interaction between simultaneous users. Virtual communities exist for groups that share every conceivable interest, hobby, or profession. Increasingly more people of all ages use the Internet as a place to meet other people for work and for play. As a consequence, chat rooms are ubiquitous on the Internet, and accordingly, the maintenance of behavioral standards and safety, especially for young people and minors, is becoming a huge societal concern.

How should the administrators of a chat site maintain standards and prevent it from degenerating into a forum for types of discussion that were never intended? How can standards be maintained within an environment like the Internet where the participants are anonymous and therefore cannot be held accountable with traditional methods? Around-the-clock real-time monitoring is not economically feasible for most Internet businesses. Some sites use basic word filters to eliminate offensive words and profanity from the chat conversation. Unfortunately such simplistic black list approaches can never be exhaustive and are easily outwitted by creative alternate spellings. Additionally, depending on the needs of the site, certain words and phrases that are neither profanity nor generally offensive need to be discouraged in order to preserve certain specific site standards. For example, in a community site for children who do not fully grasp the importance of password safety, phrases like “What's your password”, “Gimme your pass”, and “my password is” need to be discouraged. These needs arise dynamically out of the needs of a community and continually evolve. Other sites use the more extreme form of white list filtering, which only allows the use of approved words. However, not only does this stifle the natural process of language evolution within a community, it is also easy to imagine how extremely offensive phrases can be composed using words that are completely innocent in and of themselves. There are also a number of companies that employ neural network filters to try to determine offensive material. While intellectually interesting, these automated self-learning algorithms have thus far not yet proven themselves to be effective and responsive enough to be widely applicable to chat communities on the Internet. At present, when it comes to understanding and keeping up with the subtleties of language, some degree of human monitoring is still necessary. Microsoft has made some developments into this area that involve users filing complaints and monitors meting out penalties. The Microsoft system can help users and monitors in a community set and maintain community standards, but the turn-around time is dependent upon monitor availability, and response is therefore never immediate. Without any immediately effective mechanisms in place, critical situations within a chat community can degenerate quickly into general mayhem.

In the face of these inadequacies, many users of the Internet, especially parents, choose to protect themselves and their children using client-side applications like NetNanny and SurfWatch that block out entire Web sites that may contain potentially offensive language. Unfortunately, these systems often render inaccessible, for example, all sites containing medical information on breast cancer, simply because of the occurrence of the word “breast”. Other Internet Service Providers offer their users the ability to disallow chat capabilities. These methods choose to sacrifice content and interaction, the Internet's two reasons for being, in favor of safety.

Given these current trends, needs, and difficulties, what can be done to ensure a safe, clean chat environment? What tools and procedures can be implemented that can set and maintain standards within a community without making users feel oppressed or excessively controlled?

### SUMMARY OF THE INVENTION

Accordingly, the present invention is directed to the maintenance of community safety standards within an Internet community, with the intention of striking a healthy balance between community safety and open communication, while remaining cost effective to administer and maintain.

To this end, the resulting system integrates automated algorithms, human supervision, and peer monitoring to effectively set and maintain community standards, while minimizing the need for constant real-time human supervision.

The system and methods include a sophisticated filtering process that effectively blocks undesired words and phrases and evolves along with the language of the community. Aside from software implementations, the design of the system is also based on the assumption that any system of community standards and control will be much more effective if it is designed to educate the users themselves concerning what is acceptable and unacceptable behavior, as defined by the community administrators and members themselves. The tools included in this system make the expected standards of behavior clear to all users and share the responsibility of the enforcement between users and administrators. This system has been applied to an existing on-line community and the results suggest that this approach leads to two important outcomes: first, users who do not respect behavioral expectations leave the site quickly, and those that stay quickly learn and stay in compliance with set standards. Incidence of inappropriate behavior dropped by 73% during the first month of implementation. The result is a self-regulated community largely free of inappropriate behavior.

### BRIEF DESCRIPTION OF THE DRAWINGS

The accompanying drawings, which are included to provide a further understanding of the invention and are incorporated in and constitute a part of this specification, illustrate embodiments of the invention and together with the description serve to explain the principles of the invention.

FIG. 1 is a diagram providing an overview of the multi-tiered nature of the system including the community, the automated processes, and how the administrators function interactively to monitor, maintain, and improve the safety and standards of the community.

FIG. 2 is a flow chart that shows the decisions applied to a given chat phrase which are first evaluated by automated processes and may be passed on to an administrator for evaluation.

FIG. 3 is a diagram depicting the automated filtering processes that is applied to each chat phrase.

FIG. 4 is a diagram depicting the feedback process that allows for the improvement of the automated filtering processes via human intervention.

FIGS. 5A, 5B, & 5C show possible interfaces for the peer control tools supported by the present system.

FIG. 6 is a flow chart that maps the logical process of the warn tool which is one of the three peer control tools of the present invention.

FIG. 7 is a flow chart which shows the procedure of the reporting tool that allows community users to report incidents to system administrators.

### DETAILED DESCRIPTION OF THE PREFERRED EMBODIMENT

The approach to setting standards of verbal communication implemented by the present invention for Internet communities involves the integration of multiple software tools and processes as well as the collaborative interaction between software components, users of the community, as well as the administrators of the community. While the examples set forth here apply to real-time chat communication, it is understood that the present invention can apply to all forms of verbal communications within an Internet community, including but not limited to, chat, instant messages, email, and bulletin board postings. It is a feature of this invention that the standards can be flexibly set by the community administrators and the community itself to suit its needs. In a community for children, the standards could be set for the protection of children from language or topics deemed inappropriate to children by the community administrators. In a community of professionals, the standards could be set to maintain professionalism and limit digression from the professional topics at hand.

This application incorporates U.S. Pat. No. 7,925,703 by reference in its entirety. In one embodiment, the system of the present application employs a client-server architecture. In that embodiment, a client receives at least one intentionally disguised phrase, and a server communicatively coupled to the client using the Internet. The server is configured to identify at least one disguised text string that is not detectable by verbatim matching with a predetermined list of target words and phrases. The server may be configured to reject the intentionally disguised phrase when the intentionally disguised phrase matches at least one of a list of target patterns and/or a list of target words

Reference will now be made in detail to the preferred embodiments of the present invention, examples of which are illustrated in the accompanying drawings.

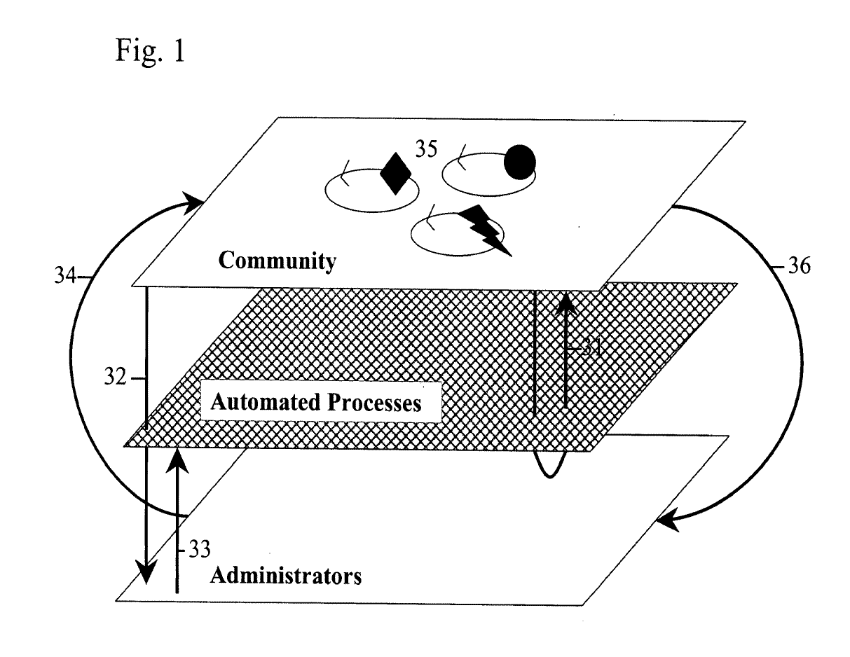

With reference to FIG. 1, chat phrases uttered by the users of the community are processed immediately by the automated filtering processes 31. Selected chat phrases are passed on to human administrators for further evaluation 32. Administrators feed back upon the automated processes 33, so that the word and phrase lists that make up the filters may evolve along with the language of the community. Standards of acceptability are communicated from administrators to community users 34 via a penalty system. The penalty is not merely censorship of the offensive phrases. It can include fines (of the virtual currency circulated in the community or real currency), loss of site privileges, and possibly banishment from the community. For users who have invested time in creating a presence within an Internet community, loss of privileges, status, and banishment are much more effective tools for behavior correction than mere instantaneous censorship. Banishment is distinct from barring a user from participating in the site. In most cases, in fact, users can return under a different identity. Instead, banishment refers to the deletion of the offender's identity in the community. The identity is marked as banished and all of its associated virtual belongings are deleted. For users who have invested significant time and energy, sometimes years of participation, building up an identity and amassing virtual goods and status, the threat of banishment is an extremely effective deterrent. Users of the community also help set site standards using a suite of peer control tools 35 to communicate to the administrators 36. The participation of community members is a crucial aspect of this system. By reviewing the logs of instances of peer-to-peer controls as well as the peer-to-administrator reports, site administrators can better understand the needs of the community and update the filters accordingly. In fact, what community members censor one another for or report to administrators are often surprising and beyond the expectation of the site managers. This is what allows this present invention the flexibility to evolve with the community it serves. The following description will elaborate upon the details of each of these five main components of this system.

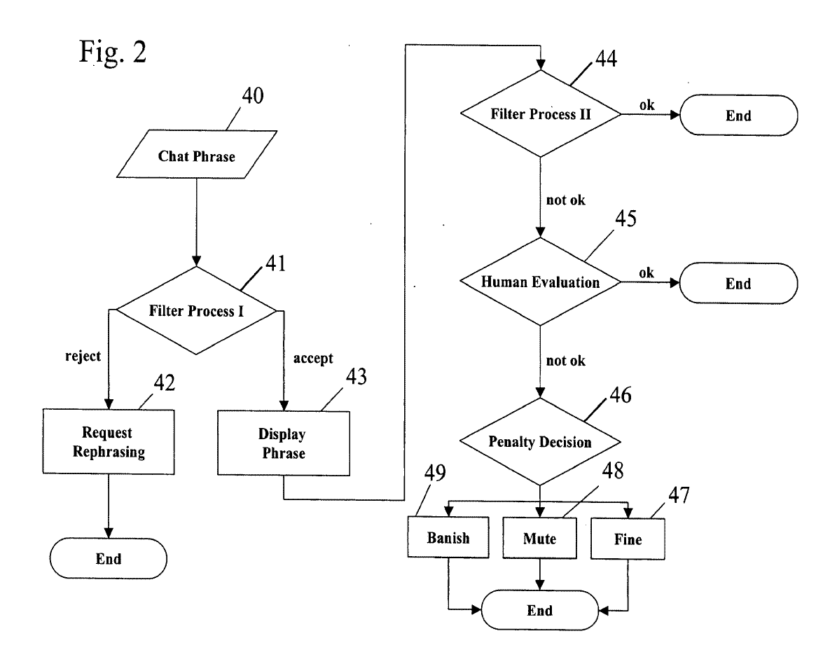

The automated filtering processes of this invention detect occurrences of words and phrases that were previously defined as inappropriate or unacceptable before they become public in the community. The decision of inappropriateness is determined by the community administrators based on observation of the community together with feedback and data collected from the community. Additionally, the list can include elements that are customized by and for a specific user. A user can designate phrases that the user does not wish to use and/or does not wish to be exposed to. For example, a parent may set up a child's user-defined list to include the family's address or telephone number so that the child cannot reveal such personal information. Or a user may wish to include in his user-defined list words that are personally offensive to him even though they are not generally considered offensive by the community. A given chat phrase 40 follows a strict procedure through the system as depicted in FIG. 2. First, it is analyzed by a set of automated filters 41 that catches not only exact matches to pre-defined words and phrases, but also popular close spellings and other alterations on the theme (to be described in more detail in following sections). If a match is found, the given phrase is rejected, and the user is asked to rephrase 42 the communication. A chat phrase is not made public to the community until it is found to be acceptable 43 by this initial filtering process. Acceptable phrases 43 are then passed through a second filtering process that involves a list of flagged words and phrases that may be objectionable or not, depending upon the context in which it was used step 44. Phrases flagged by this process are shipped on to a human administrator step 45, who accesses a Web page tool that shows the flagged phrase and the surrounding conversation as well as the behavioral history of the offender. The administrator reviews this information and makes a judgement about the offense and metes out a penalty corresponding to the seriousness of the offense 46. For the community in which this system has been implemented and tested, the penalties include fines 47 and suspension of communication privileges 48. For repeated offenders and the most serious offenses, the user may be permanently banished 49 from the community. In any case, the penalties can be applied using the same Web page tool.

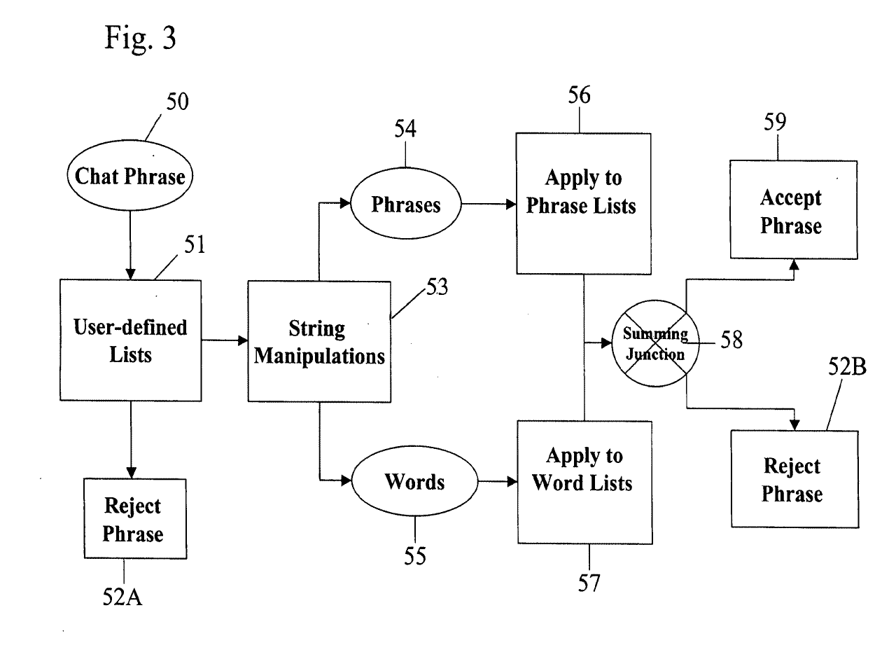

The special characteristic of the automated filtering processes employed in this invention is their ability to detect words and phrases that are less-than-exact matches to items on a pre-defined list. FIG. 3 illustrates the procedure. Each chat phrase 50 is first analyzed for matches against two lists of words and phrases that can be personalized by each individual user 51:

1. words and phrases that the user do not wish to say (send)

2. words and phrases that the user do not wish to see (receive)

The personal list for outgoing chat phrases is a useful safety feature for preventing personal information such as family names, street addresses, etc. from being communicated unwittingly. The personal list for incoming chat phrases allows users to tailor their on-line environments to their own personal standards.

If a positive match is found, the phrase is immediately rejected as shown in block 52A. Otherwise, it is subjected to a series of string manipulations 53 that result in a group of phrases and words. These alternate versions and derived components of the original phrase represent stripped down versions of the original phrase. The purpose of these manipulations is to detect target words even if they have been disguised by extra inserted spaces, periods, and/or other symbols. For the community in which this system has been implemented and tested, the group of phrases 54 includes:

all-lowercase version of original phrase

1. all-lowercase version where all non-letters are substituted by periods

2. all-lowercase version where all non-letters and non-spaces are substituted by periods

3. all-lowercase version where all consecutive periods are coalesced into one

4. all-lowercase version where all consecutive spaces coalesced into one

The group of words 55 includes:

1. words in the original phrase split based on spaces

2. words in the original phrase split based on non-letters

3. words in which all non-letters are converted into periods

4. words in which all consecutive periods are coalesced into one

The group of phrases is then matched to a list of patterns 56 that contain target patterns that include real words (typical curse words, for example), close spellings of these words, as well as permutations of these words with periods and spaces inserted between letters. The group of phrases is also matched to a list of longer, less typical offensive words as well as phrases. The group of words is processed for exact matches to a list of words and for start-of-word matches to another list of words that are often used with suffixes, block 57.

If a positive match emerges from any part of the above procedure as shown in the summing or comparison step 58, the chat phrase is rejected 52B. The user is asked to rephrase the communication, and the rejected phrase is never made public to the community. Only if the phrase is accepted, a shown in step 59, is the phrase presented to the community.

It should be emphasized that the words and phrases to be included in these lists should be determined from analysis of the chat phrases used within the given community. The list of rejected phrases 52B, for instance, should comprise of the most popular offensive words in the community, words for which the users will spend considerable time and effort attempting to bypass the filter by using alternate spellings, substituting letters with symbols, inserting spaces between letters, etc. These lists should also be continually updated and improved in order to keep up with the natural evolution of language in a community. This updating is a multi-faceted process that involves observation of the evolving language of the community, review of the instances of punishments meted out by the administrators to understand trends in offenses, review of the instances of peer-to-peer control to understand what the community deems unacceptable, and review of the peer-to-administrator reports to understand what the community considers most offensive.

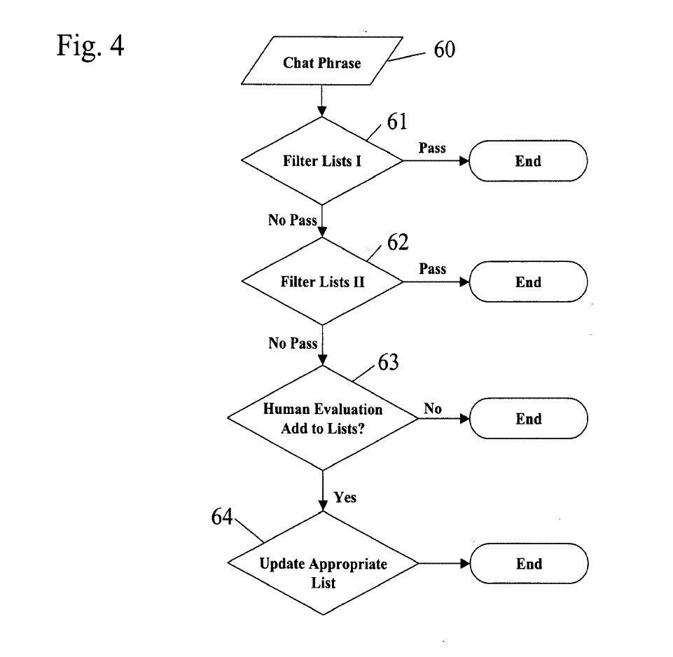

The methodology for this improvement process for this system is depicted in FIG. 4. Even after a chat phrase has passed successfully through the processes illustrated in FIG. 3 and is made public, the analysis continues. This chat phrase 60 is analyzed first by filter list I in step 61, then using yet another set of filters that determine if it should be passed on to a human evaluator using filter list II in step 62. The filter lists for this part of the process consist of words and phrases that may or may not be offensive, depending upon its context. A human evaluator 63 is therefore the best judge. If the administrators notice that a given word or phrase is by and large used in an offensive manner and would therefore be more efficiently dealt with by the initial automated filtering process 61, this word or phrase can then be added to the appropriate pattern lists or phrases lists, step 64. Analysis shows also that a good indicator of offensive words and phrases in a conversation is the presence of other offensive words or phrases. By forwarding suspected offensive communications together with the surrounding conversation to the administrators, the system also allows the administrators to notice potential new offensive words and phrases to be included in the analysis and be apprised of new developments in the language of the community.

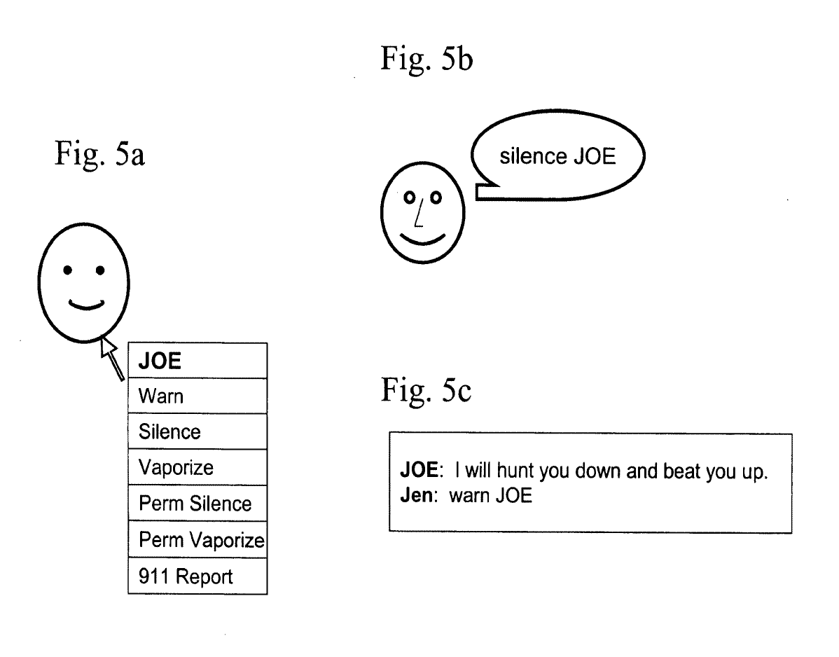

One of the main components of this system is a set of user tools that allow users of the community to protect themselves, alert others in the community of inappropriate situations, and consequently help define the standards of behavior in the community. These peer control safety tools include warn, silence, vaporize, permanent silence, and permanent vaporize. The system supports two types of user-side interface, as depicted in FIG. 5. One is a graphical interface (FIG. 5A) for use in a graphical chat environment where users are represented by avatars. A drop-down menu is invoked when the user double-clicks on an avatar on the screen. The drop-down menu gives a list of the peer control tools available to the user, and the user simply clicks on the desired tool. The textual interface can be used in both graphical chat environments (FIG. 5B) as well as traditional textual chat environments (FIG. 5C). In each of these cases, the user simply types in the name of the tool followed by the name of the user on which the tool should be applied. Both the textual and the graphical interface have been tested, and both prove to be intuitive and easy to use even for young users between the ages of 8 to 12.

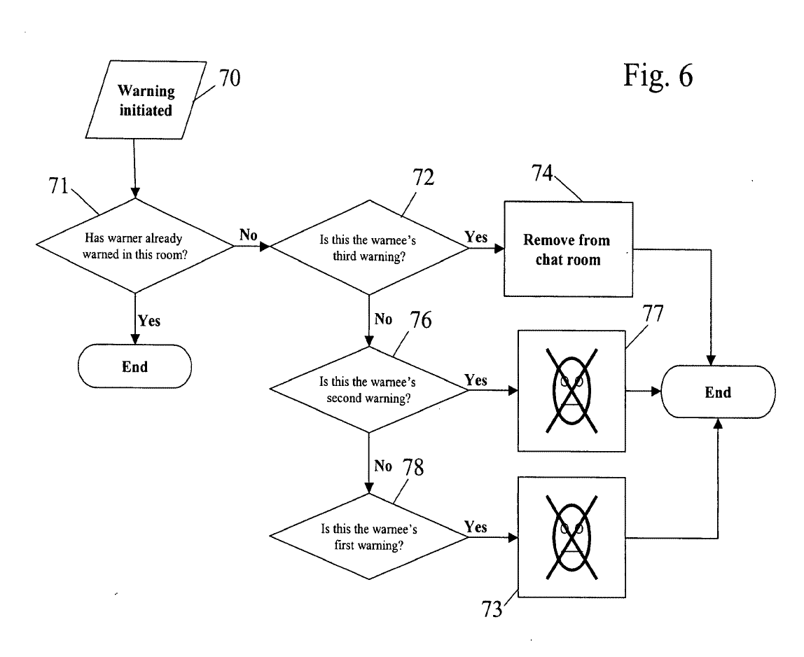

The process involved with using the Warn Tool is illustrated in FIG. 6. This tool allows users to indicate proactively to another user that he/she is behaving in an unacceptable manner 70. A clear visual cue that is visible to all members in the chat environment appears, calling all users to alert immediately. In a graphical environment, this visual cue may be a large X marked across the face of the user being warned 73. In a textual environment, this visual cue may be a change in color or on-off blinking of the name of the user being warned for the first time 78. If a user is warned a second time 76 in the same chat area, the visual cue changes to indicate the escalation of the situation 77. For example, the X marked across the user's face changes from yellow to red. If the user is warned a third time 72, he/she is ousted from the chat area for a certain amount of time 74. To prevent abuse of this tool, each user is only allowed to use the Warn Tool once in a given chat area during the course of a chat session 71.

The Silence Tool allows users to decide themselves when they no longer want to listen to an offensive or annoying user. When User A applies this tool on User B, chat phrases submitted by User B is no longer transmitted to User A while they are in the same chat area during the current session. User B is still able to communicate with all other users. The Vaporize Tool allows users to stop seeing another user. When User A applies this tool on User B, User B disappears from User A's screen for the duration of User A's stay in this chat area during the current session. User B is still seen by all other users and is still able to see User A. The permanent versions of both the Silence Tool and the Vaporize Tool allow the term of silence and disappearance to be extended beyond the current session. User B remains silent/invisible to User A until User A decides otherwise and makes the corresponding changes via a separate Web tool.

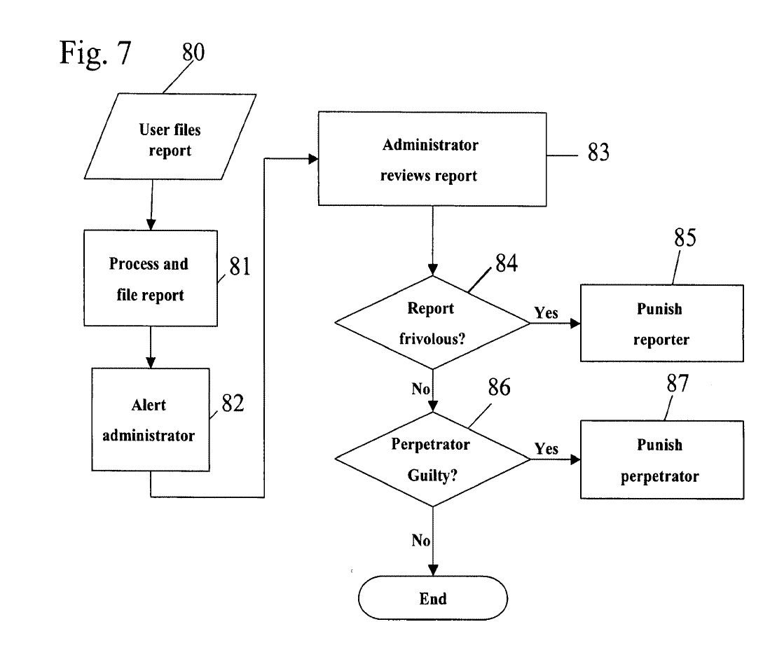

Lastly, the system in this invention allows users of the community to report directly to the administrators of the community, alerting them to the most serious safety situations on the site. It also allows administrators to be kept apprised of the constantly evolving standards in the community, so that the filtering processes of the system may be adjusted and improved to match the standards desired by the community. This is done via the Report Tool, the process of which is illustrated in FIG. 7. Users are asked to file reports 80 as close as possible to the time of the incident, from the same chat area where the incident occurred. When making a report, the reporter is asked to include the time and location of the incident, as well as the reason for the report 81. Upon submittal, the report is inserted into the database of the system and system administrators are notified via email 82. An administrator uses an online Web tool to view the report 83. The report shows the actual time and location of the report, all chat phrases submitted by the perpetrator during this session, and all chat phrases submitted in this chat area from a certain amount of time prior to the arrival of the reporter in the chat area to the time of the report. The report also includes the behavioral history of both the perpetrator and the reporter. The administrator makes a decision regarding the validity of the report based on this information 84. If the report is judged false or frivolous, the reporter is penalized 85, so as to maintain the standards of use of this tool. If the perpetrator is judged guilty 86, the perpetrator is penalized 87. The perpetrator receives also a notice that indicates the incident in question, the penalty applied, and an explanation of why the behavior is unacceptable. In all cases, the reporter is sent a Report Decision notifying him/her of the decision result. This notification may also suggest that the reporter make use of the other community safety tools such as silence and vaporize. If a penalty was not applied, the reporter also receives an explanation. The online Web tool used by the administrators includes a set of drop-down menus and buttons that trigger pre-defined penalties, explanations, and suggestions that aid in the standardization of decisions and responses.

The five components described above (the automated filtering process, the evaluation and penalty process, the filter improvement process, the peer-to-peer control tools, and the peer-to-administrator report tool) make up the system in this invention. These processes, methodologies, and tools allow users and the administrators of an online chat community to act synergistically to maintain safety and set standards within a community. The implementation of this system in an existing online community has resulted in a 73% reduction of inappropriate and/or offensive chat incidents within one month.

While the invention has been described in detail and with reference to specific embodiments thereof, it will be apparent to those skilled in the art that various changes and modifications can be made therein without departing from the spirit and scope thereof. Thus, it is intended that the present invention covers the modifications and variations of this invention provided they come within the scope of the appended claims and their equivalents.

What is claimed is:

1. A filtering system comprising:
an Internet-enabled computer system, the computer system receives a input phrase and executes a plurality of automated filtering processes to identify at least one unacceptable text string that is not detectable by exact matching of at least a portion of the input phrase to a predetermined list of target strings and a predetermined list of target phrases;
instructions of a first automated filtering process comparing at least a portion of the input phrase to at least one user defined predetermined list of target strings and phrases;
instructions of a second automated filtering process transforming the input phrase to detect an unacceptable text string that is disguised using at least one character selected from a group of characters comprising: inserted letters, inserted spaces and inserted symbols;
instructions of the second automated filtering process performing a preprocessing string manipulation on the input phrase that results in a group of alternate phrases and a group of alternate words, wherein the group of alternate phrases is matched to a list of target patterns that includes a plurality of words, a plurality of close spellings of words, and a plurality of permutations of words, wherein the group of alternate words is processed for matches to a list of target strings; and
instructions of the second automated filtering process rejecting the input phrase when at least a portion of the input phrase matches at least one of a target pattern of the list of target patterns and a target string of the list of target strings.

2. The filtering system of claim 1 further comprises a first list of words and phrases for a plurality of outgoing words and phrases that are associated with personal information for a user.

3. The filtering system of claim 1 further comprises a second list of words and phrases for a plurality of incoming words and phrases that allows each user to tailor their on-line environments to their own standards.

4. The filtering system of claim 1 wherein the list of target strings is selected from a group of target strings consisting of a plurality of real words, a plurality of close spellings of these real words, a plurality of permutations of these real words having symbols and spaces inserted between the letters, a plurality of words that are used with suffixes and a plurality of phrases.

5. The filtering system of claim 4 wherein the result of the string manipulation is matched against the list of target strings further resulting in a match or a non-match.

6. The filtering system of claim 5 further comprising a matched word or a matched phrase that has been identified through the second automated filtering process, wherein the matched word or the matched phrase is not made visible to the online community.

7. The filtering system of claim 6 further comprising a request to rephrase the matched word or the matched phrase.

8. The filtering system of claim 7 wherein a rephrased matched word or a rephrased matched phrase is presented to the online community, when the rephrased matched word or the rephrased matched phrase results in a non-match.

9. A filtering method comprising:
receiving a input phrase at an Internet-enabled computer system, the Internet-enabled computer comprising stored instructions for a plurality of automated filtering processes to identify at least one unacceptable text string that is not detectable by exact matching of at least a portion of the input phrase to a predetermined list of target strings and a predetermined list of target phrases;
processing instructions of a first automated filtering process comparing at least a portion of the input phrase to at least one user defined predetermined list of target strings and phrases;
processing instructions of a second automated filtering process transforming the input phrase to detect an unacceptable text string that is disguised using at least one character selected from a group of characters comprising: inserted letters, inserted spaces and inserted symbols;
processing instructions of the second automated filtering process performing a preprocessing string manipulation on the input phrase that results in a group of alternate phrases and a group of alternate words, wherein the group of alternate phrases is matched to a list of target patterns that includes a plurality of words, a plurality of close spellings of words, and a plurality of permutations of words, wherein the group of alternate words is processed for matches to a list of target strings; and
processing instructions of the second automated filtering process rejecting the input phrase when at least a portion of the input phrase matches at least one of a target pattern of the list of target patterns and a target string of the list of target strings.

10. The filtering method of claim 9 further comprising identifying a first list of words and phrases for a plurality outgoing words and phrases that are associated with personal information for a user.

11. The filtering method of claim 9 further comprising identifying a second list of words and phrases for a plurality of incoming words and phrases that allows each user to tailor their on-line environments to their own standards.

12. The filtering method of claim 9 wherein the list of target strings is selected from a group of target strings consisting of a plurality of real words, a plurality of close spellings of real words, a plurality of permutations of real words having at least one character inserted between the letters, a plurality of words that are used with suffixes and a plurality of phrases.

13. The filtering method of claim 12 wherein the result of the string manipulation is matched against the list of target strings further resulting in a match or a non-match.

14. The filtering method of claim 13 further comprising identifying a matched word or a matched phrase that has been identified through the second automated filtering process, wherein the matched word or the matched phrase is not made visible to the online community.

15. The filtering method of claim 14 further comprising communicating a request to rephrase the matched word or the matched phrase.

16. The filtering method of claim 15 wherein a rephrased matched word or a rephrased matched phrase is presented to the online community, when the rephrased matched word or the rephrased matched phrase results in a non-match.
